(19) United States
(12) Patent Application Publication
(10) Pub. No.: US 2016/0134332 A1
(43) Pub. Date: May 12, 2016

(54) USING A POWER OVER ETHERNET DEVICE TO SUPPLY MULTIPLE DC POWER TO CONNECTED DEVICES AND APPLICATION THEREOF

(71) Applicant: WEN-HSIEN LAI, Taoyuan Hsien (TW)

(72) Inventor: WEN-HSIEN LAI, Taoyuan Hsien (TW)

(73) Assignee: IN WIN DEVELOPMENT, INC., Taoyuan Hsien (TW)

(21) Appl. No.: 14/537,501

(22) Filed: Nov. 10, 2014

(51) Int. Cl. H04B 3/54; H02J 1/00; H04L 12/10

(52) U.S. Cl. CPC H04B 3/548; H04L 12/10; H02J 1/00

(57) ABSTRACT

The present invention disclosed a using a POE (Power over Ethernet) device to supply multiple DC (direct current) power to connected devices and application thereof, which is enables supplying different DC (direct current) voltages produced by a PD (Powered Device) module from a PSE (Power Source Equipment) of a POE (Power over Ethernet) device. The different DC voltage output is supplied for use by external devices, and uses a single POE power connection to enable supplying power to separated or interconnected type external devices.

### BACKGROUND OF THE INVENTION

(a) Field of the Invention

The present invention relates to using a POE (Power over Ethernet) device to supply multiple DC (direct current) power to connected devices and application thereof, and more particularly to a method of creating different voltages from the POE power source and providing external connections to allow the powering of separated or connected devices using a single POE power connection.

(b) Description of the Prior Art

It is known that POE (Power Over Ethernet) is a technology for transmitting power and data to a device through a twisted pair wire in the Ethernet. Devices including internet telephones, wireless access points, web cameras, hubs, computers, and the like, can be supplied with power by the POE technology. As the electronic equipment powered by the Ethernet can be used without requiring an additional power socket, the time and money spent in configuring the power cable can be saved, thereby reducing the cost of the entire device.

### SUMMARY OF THE INVENTION

Accordingly, the primary object of the present invention is using a POE (Power over Ethernet) device to supply multiple DC (direct current) power to connected devices and application thereof, wherein a PD (Powered Device) that passes POE (Power over Ethernet) DC voltage through a bridge rectifier, which is then connected to a POE controller. Finally, the POE voltage is regulated to create the voltage level required by the system and supplies this voltage to the system power circuits. This is done within the device with the exception of a POE splitter which has the same function but connects the regulated POE voltage via an external connection to a non-POE enabled device.

To enable a further understanding of said objectives and the technological methods of the invention herein, a brief description of the drawings is provided below followed by a detailed description of the preferred embodiments.

### BRIEF DESCRIPTION OF THE DRAWINGS

FIG. 1 shows a circuit block diagram according to a power system of the present invention.

FIG. 2 shows a circuit block diagram according to a PD (Powered Device) module of the present invention.

### DETAILED DESCRIPTION OF THE PREFERRED EMBODIMENTS

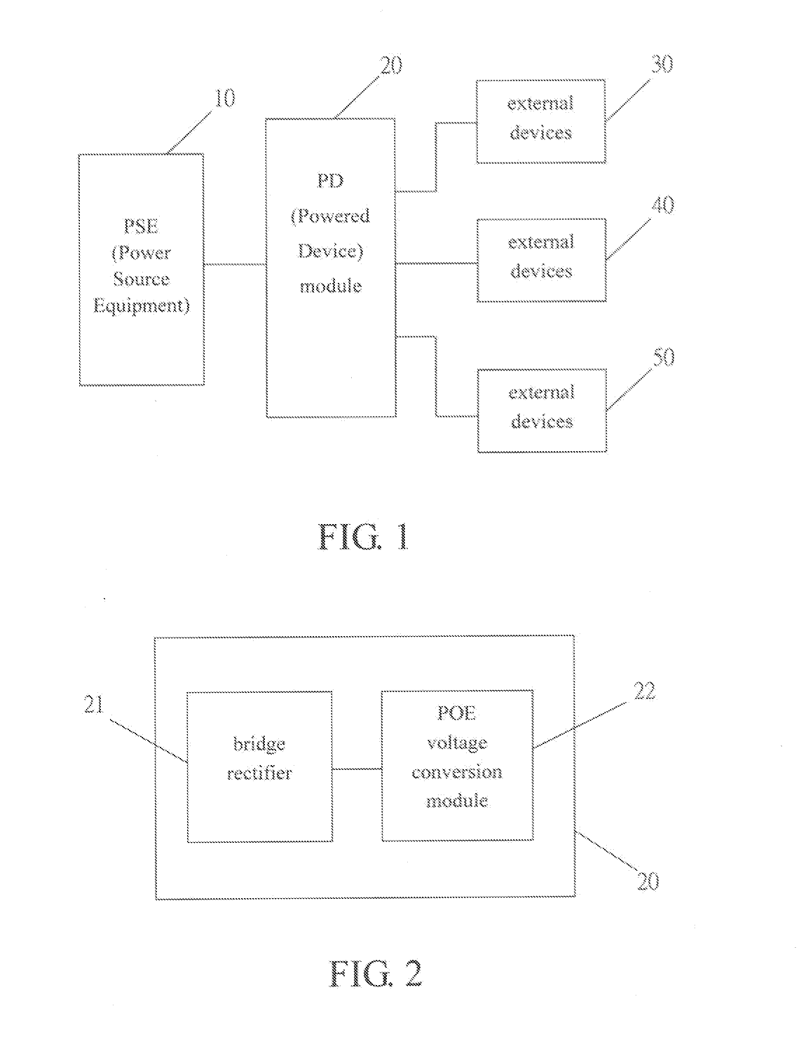

Referring to FIG. 1, which shows a circuit block diagram according to a power system of the present invention, wherein the power source of the present invention is a PSE (Power Source Equipment) 10. The voltage from the PSE 10 is supplied to a PD (Powered Device) module 20 via a RJ-45 network cable.

Referring to FIG. 2, a bridge rectifier 21 located inside the PD module 20 carries out voltage rectification and filtering of a signal source via a POE voltage conversion module 22, thereby converting the signals to comply with POE (Power over Ethernet) IEEE802.3AF, AT, and POH (Power over HDbaseT) communication protocol standards, and allocating the power output (the voltage is from 57V→19V). The voltage is also regulated via the internal module (the voltage can be from 19V→12V or from 19V→14V . . . ) to supply power of different voltages for use by a plurality of external devices 30, 40, 50 that can be separated (separated by relatively large distances) or connected (separated by relatively small distances).

The above method creates a second power connection to the POE voltage to allow for a second power connection. The second power connection may have the same voltage as the PD (Powered Device) module or it may have a different voltage. The position of the second power connection depends on what the voltage of the other connected devices will be. The second power connection is typically external to the main system and allows for power from the POE connection to be used to power other devices that are not connected to the actual POE connection.

For a configuration where the other power connections are the same voltage as the POE connected device the power connection is located at the output of the voltage regulation function for the system.

For a configuration where the other power connections are not the same voltage as the POE connected device, the power connection is located before the voltage regulation function for the system. The power connection to the other devices may be controlled in a way to control the power state of the other connected devices.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A Using a POE (Power over Ethernet) device to supply multiple DC (direct current) power to connected devices and application thereof, wherein, in a POE (Power over Ethernet) architecture, power is supplied to a PD (Powered Device) module from a PSE (Power Source Equipment), and the PD module converts signals to comply with POE IEEE802.3AF, AT, and POH (Power over HDbaseT) communication protocol standards, and then allocates the power output, finally regulating the voltage through an internal module to supply power of different voltages for use by a plurality of external devices.

2. The Using a POE (Power over Ethernet) device to supply multiple DC (direct current) power to connected devices and application thereof according to claim 1. wherein the interior of the PD Module comprises a bridge rectifier diode and a POE voltage conversion module.
